(19) United States
(12) Patent Application Publication
(10) Pub. No.: US 2025/0260173 A1
(43) Pub. Date: Aug. 14, 2025

(54) METAMATERIAL BASED REFLECTIVE UNIT CELL FOR INTELLIGENT REFLECTIVE SURFACES AND METHOD OF MANUFACTURING THEREOF

(71) Applicant: L&T TECHNOLOGY SERVICES LIMITED, Chennai (IN)

(72) Inventors: KHEMANI RAKESH VASDEV, Bengaluru (IN); FARAZ AHMAD, Patna (IN)

(21) Appl. No.: 19/045,620

(22) Filed: Feb. 5, 2025

(30) Foreign Application Priority Data
Feb. 8, 2024 (IN) 202441008767

(51) Int. Cl. H01Q 15/00; H01Q 1/38; H01Q 15/14

(52) U.S. Cl. CPC H01Q 15/0086; H01Q 1/38; H01Q 15/141

(57) ABSTRACT

A method of manufacturing a reflective meta-surface is provided. The reflective meta-surface comprises a plurality of unit cells arranged in a pre-defined pattern. The plurality of unit cells is formed by disposing a conducting plane on a top surface of a quadrilateral-shaped substrate and a loading plane on a bottom surface of the substrate. The conducting plane comprises a first outer surface and a first inner surface. The first inner surface comprises a quadrilateral structure with sides parallel to corresponding sides of the top surface of the substrate. The first outer surface comprises four T-shaped structures. The loading plane comprises a second outer surface and a second inner surface. The second outer surface comprises a second quadrilateral structure. The second inner surfaces comprise a plus-shaped structure.

### TECHNICAL FIELD

This disclosure relates generally to reflective surfaces and more particularly to metamaterial based reflective unit cell for intelligent reflective surfaces.

### BACKGROUND

Use of millimeter waves in wireless communication is inevitable and yet highly susceptibility to distortion. Millimeter waves encounter difficulties in maintaining their integrity, especially when there is no direct line of sight of signals. When millimeter waves encounter obstacles or obstructions, they become prone to attenuation, leading to significant distortion. Achieving a complete and reliable signal transmission and reception becomes almost impossible in scenarios where line-of-sight communication is disrupted. Millimeter waves, when obstructed undergo distortion that renders them unsuitable for non-line-of-sight communications. Extracting original information from such distorted signals becomes challenging as the signal loss due to distortion can result in a partial or corrupted transmission. Consequently, making reconstruction of the millimeter-waves difficult. In order to overcome the challenges associated with millimeter-wave communication in non-line-of-sight scenarios, special antennas have been designed to shorten the communication distance for achieving enhanced network coverage and capacity. However, deployment of such antennas incurs higher energy consumption and deployment/backhaul/maintenance cost. Further, use of such antenna may lead to more severe and complicated network interference issue.

Therefore, there is a requirement to ensure effective transmission of millimeter-waves by mitigating distortion in non-line of sight scenarios.

### SUMMARY OF THE INVENTION

In an embodiment, a reflective meta-surface is disclosed. The reflective meta-surface may include a plurality of unit cells that may be arranged in a pre-defined pattern. In an embodiment, each of the plurality of unit cells may include a quadrilateral-shaped substrate of dielectric material that may include a top surface and a bottom surface. Further, each of the plurality of unit cells may include a conducting plane disposed on the top surface and a loading plane disposed on the bottom surface. In an embodiment, the conducting plane may include a first outer surface and a first inner surface. In an embodiment, the first inner surface may include a first quadrilateral structure with sides parallel to corresponding sides of the top surface of the substrate. In an embodiment, the first outer surface may include four T-shaped structures. In an embodiment, each of the four T-shaped structures may include a horizontal arm aligned with the corresponding side of the top surface of the substrate. In an embodiment, the each of the four T-shaped structures may further include a vertical arm that may include a first end and a second end. In an embodiment, the first end of the vertical arm may be connected to the corresponding horizontal arm and the second end may be connected to the corresponding side of the first quadrilateral structure. Further, in an embodiment, the loading plane may include a second outer surface and a second inner surface. In an embodiment, the second outer surface may include a second quadrilateral structure with sides coinciding with corresponding sides of the bottom surface of the substrate. In an embodiment, the second inner surface may include a plus-shaped structure. In an embodiment, the conducting plane and the loading plane may be placed on the top surface and the bottom surface respectively such that a center of the plus-shaped structure and a center of the first quadrilateral structure may be colincar.

In another embodiment, a method of manufacturing a reflective meta-surface is disclosed. The method may include arranging a plurality of unit cells in a pre-defined pattern. In an embodiment, each of the plurality of unit cells may be formed by disposing a conducting plane on a top surface of a quadrilateral-shaped substrate and a loading plane on a bottom surface of the substrate. In an embodiment, the substrate may be made of a dielectric material. In an embodiment, the conducting plane may include a first outer surface and a first inner surface. In an embodiment, the first inner surface may include a first quadrilateral structure with sides parallel to corresponding sides of the top surface of the substrate. In an embodiment, the first outer surface may include four T-shaped structures. In an embodiment, each of the four T-shaped structures may include a horizontal arm aligned with the corresponding side of the top surface of the substrate. In an embodiment, the each of the four T-shaped structures may further include a vertical arm that may include a first end and a second end. In an embodiment, the first end of the vertical arm may be connected to the corresponding horizontal arm and the second end may be connected to the corresponding side of the first quadrilateral structure. In an embodiment, the loading plane may include a second outer surface and a second inner surface. In an embodiment, the second outer surface may include a second quadrilateral structure with sides coinciding with corresponding sides of the bottom surface of the substrate. In an embodiment, the second inner surface may include a plus-shaped structure. In an embodiment, the conducting plane and the loading plane may be placed on the top surface and the bottom surface respectively such that a center of the plus-shaped structure and a center of the first quadrilateral structure may be colinear.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 illustrates an exploded view of a unit cell 101 used to make a reflective meta-surface, in accordance with an embodiment of the present disclosure.

FIG. 2 illustrates a perspective top view of the unit cell 101, in accordance with an embodiment of the present disclosure.

FIG. 3 illustrates a bottom perspective view of the unit cell 101, in accordance with an embodiment of the present disclosure.

FIG. 4 is a flowchart of a methodology of manufacturing the IRS or reflective meta-surface, in accordance with an embodiment of the present disclosure.

FIG. 5 illustrates an exemplary deployment scenario of an IRS, in accordance with an embodiment of the present disclosure.

FIG. 6A and FIG. 6B show transmission and reflection graphs, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope being indicated by the following claims.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

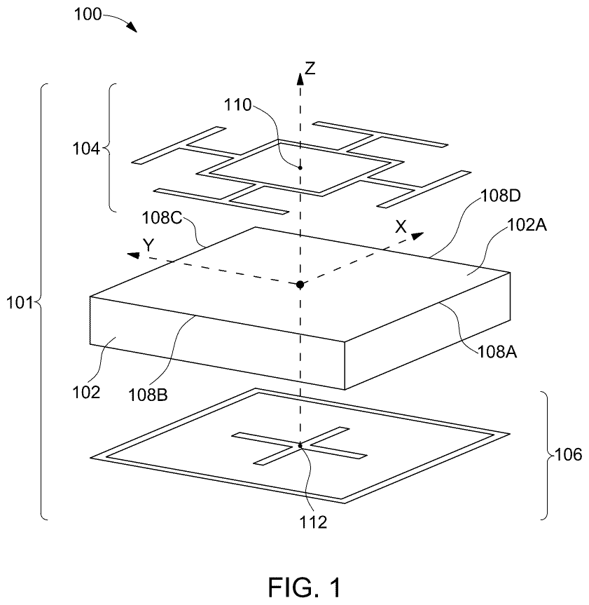

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-6B. As summarized above, in one broad aspect, the present invention provides a reflective meta-surface and a method of manufacturing a reflective meta-surface thereof.

It is to be noted that metamaterials are engineered materials to have properties that may manipulate electromagnetic waves in unique ways to achieve desired outcome. Metamaterials derive their properties not from the properties of the base materials, but from their newly designed structures. Their precise shape, geometry, size, orientation and arrangement gives them their unique properties capable of manipulating electromagnetic waves: by blocking, absorbing, enhancing, or bending waves, to achieve benefits that go beyond what is possible with conventional materials. Appropriately designed metamaterials can affect waves of electromagnetic radiation or sound in a manner not observed in bulk materials. Metamaterials that exhibit a negative index of refraction for wavelengths have been the focus of a large amount of research.

Metamaterials may be engineered to change their phase responses and are used for designing intelligent reflective surfaces (IRS). Such IRS may be used to reflect and redirect millimeter waves in order to facilitate non-line-of-sight communication. IRS also referred to herein as meta-surface may be programed or designed to cause parasitic reflections in a constructive way so that the N258 band can be used more efficiently. This involves complementing signals in blind spots and bending them around obstacles to improve the robustness of connections.

Accordingly, the present disclosure provides a reflective meta-surface made using metamaterial and method of manufacturing thereof. The reflective meta-surface may act as an IRS and is formed by arranging a plurality of unit cells in a predefined pattern. In an embodiment, the predefined pattern may include a first set of unit cells of the plurality of unit cells arranged in x-direction and a second set of unit cells of the plurality of unit cells arranged in y-direction to form a planar structure. The plurality of unit cells are repeated periodically to form a planar structure to build the metasurface that may function as an IRS. The IRS may direct the radio waves to blind spots and fill in gaps in the network coverage. IRSs can also provide an alternative low-cost solution to reconfigure the beam's direction towards fixed unserved spots instead of the high-cost IRS.

Referring now to FIG. 1, an exploded view 100 of a unit cell 101 used to make the reflective meta-surface (also referred to as IRS) is illustrated, in accordance with an embodiment of the present disclosure. As discussed above, the reflective meta-surface may include a plurality of unit cells 101 arranged in a pre-defined pattern.

As shown, each unit cell 101 may include a quadrilateral-shaped substrate 102 made of a dielectric material. The quadrilateral-shaped substrate 102 may include a top surface 102A and a bottom surface (not shown). In an embodiment, the substrate 102 is a non-conductor of electricity. In an embodiment, the substrate 102 may be made of materials such as, but not limited to, FR-4, FR-2, polyimide, polytetrafluoroethylene, etc. In an embodiment, the substrate 102 may allow creation of electric field but may not allow the flow of current through it. The unit cell 101 may further include a conducting plane 104 that may be disposed on the top surface 102A. The unit cell 101 may further include a loading plane 106 that may be disposed on the bottom surface (not shown). In an embodiment, the conducting plane 104 and the loading plane 106 may be made of an electrically conductive material. In an embodiment, examples of the electrically conductive material may include, but is not limited to, copper, aluminum, silver, gold, brass, bronze, graphite, carbon nanotubes, conductive polymers, etc. In an embodiment, the disposition of the conducting plane 104 and the loading plane 106 and a dielectric constant of the substrate 102 may configure each of the unit cell 101 to have inductance and capacitance effects to reflect the electromagnetic waves in a predefined frequency range. In an exemplary embodiment, the loading plane 106 may be configured to generate an about band stop effect. It is to be noted, that it is impossible to get a complete band stop effect, the radiation from ground plane may be minimized into more reflective nature. In an embodiment, the loading plane 106 may serve as a dipole of quarter wavelength and contributes to resonance in the broadside direction. In an embodiment, the substrate 102 may have a predefined thickness and have sides 108A-D extending along the x-axis and the y-axis. In an embodiment, the sides 108A-D may be equal to each other making the top-surface 102A and the bottom-surface 102B square shaped. It should be noted that a center 110 of the conducting plane 104 and a center 112 of the loading plane 106 are colinear as depicted along the z-axis. In an embodiment, the conducting plane 104 and the loading plane 106 may produce inductance and capacitance as a function of resonance frequency. In an embodiment, resonance may involve the interaction of electromagnetic wave with a structure at a specific frequency. In an exemplary embodiment, if there is no resonance, the waves may interfere destructively, leading to cancellation or reduction of the electric currents at the conducting plane 104. In another embodiment, if the resonance is achieved, the electric currents may be manipulated, this may lead to enhanced electric currents at specific frequencies.

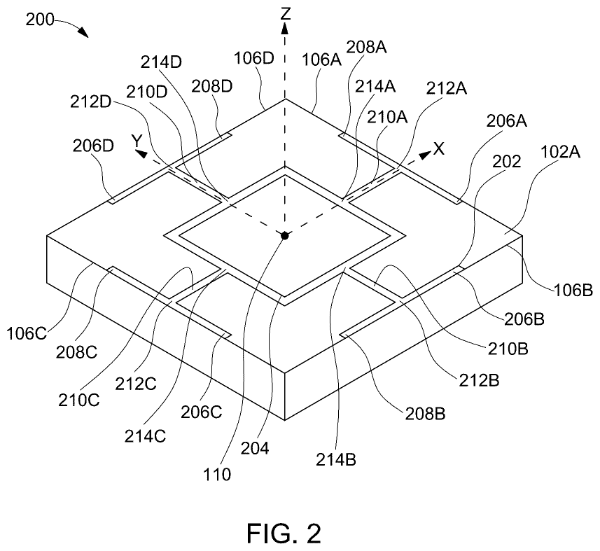

Referring now to FIG. 2, a perspective top view 200 of the unit cell 101 is illustrated, in accordance with an embodiment of the present disclosure. As shown in FIG. 2, the conducting plane 104 disposed on the top surface 102A of the substrate 102 is shown. The conducting plane 104 may be made of electrically conducting material and designed to include a first outer surface 202 and a first inner surface 204. In an embodiment, the first inner surface 204 is shaped as a first quadrilateral structure with sides parallel to corresponding sides 108A-D of the top surface 102A of the substrate 102. In an embodiment, length of sides of the first quadrilateral structure forming the first inner surface 204 may be less than length of the sides 108A-D of the top surface 102A of the substrate 102. The first outer surface 202 includes four T-shaped structures 206A-D. Each of the four T-shaped structures 206A-D may include a horizontal arm 208A-D aligned with the corresponding side 106A-D of the top surface 102A of the substrate 102. Further, each of the four T-shaped structures 206A-D may include a vertical arm 210A-D. Each of the vertical arms 210A-D may include a first end 212A-D that may be connected to the corresponding horizontal arm 208A-D and a second end 214A-D may be connected to the corresponding side of the first quadrilateral structure 204.

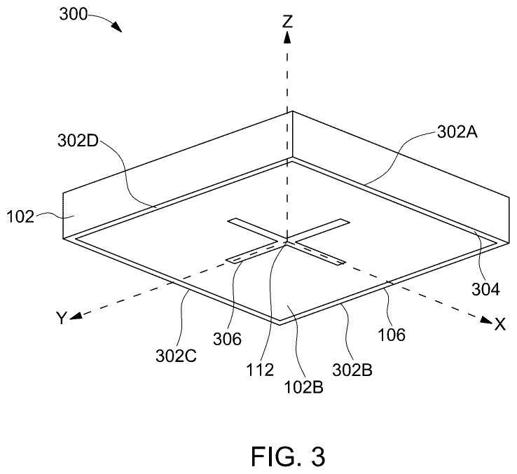

Referring now to FIG. 3, a bottom perspective view 300 of the unit cell 101 is illustrated, in accordance with an embodiment of the present disclosure. As shown in FIG. 3, the loading plane 106 disposed on a bottom surface 102B of the quadrilateral shaped substrate 102 is illustrated. The loading plane 106 may include a second outer surface 304 and a second inner surface 306. In an embodiment, the second outer surface 304 may include a second quadrilateral structure with sides coinciding with corresponding sides 302A-D of the bottom surface 102B of the substrate 102. In an embodiment, length the sides of the second quadrilateral structure 304 is same as the length of the sides 302A-D of the bottom surface 102B of the substrate 102. In an embodiment, the second inner surface 306 may include a plus-shaped structure. Further, the arms forming the plus-shaped structure 306 may be perpendicular to the sides 302A-D. In an embodiment, the plus-shaped structure 306 may act as a dipole antenna. In an exemplary embodiment, the dipole antenna is a fundamental type of radio antenna that may consist of two conductive elements, often referred to as “poles” or “arms,” which are typically oriented in a straight line and separated by a gap. In an embodiment, the dipole antennas are known for their specific radiation pattern, where the electromagnetic radiation is strongest in directions perpendicular to the axis of the antenna (broadside direction). It is to be noted that center of the plus-shaped structure 112 and the center of the first quadrilateral structure 110 (as shown in FIG. 1 and FIG. 2) are colincar.

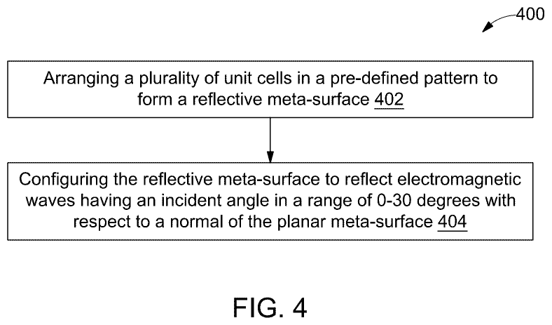

Referring now to FIG. 4, a flowchart 400 depicting a methodology of manufacturing the IRS or reflective meta-surface is illustrated, in accordance with an embodiment of the present disclosure.

At step 402, a plurality of unit cells 101 may be arranged in a pre-defined pattern to form a reflective meta-surface or an IRS. In an embodiment, the pre-defined pattern may include a first set of unit cells from the plurality of unit cells 101 arranged in x-direction and a second set of unit cells from the plurality of unit cells 101 arranged in y-direction. Further at step 404, the reflective meta-surface may be configured to reflect electromagnetic waves that may have an incident angle in a range of 0 to 30 degrees with respect to a normal of the reflective meta-surface. In an embodiment, the reflective meta-surface may be configurable to reflect electromagnetic waves in the predefined frequency range of n258 band of the electromagnetic spectrum for wireless communication. In an embodiment, the reflective meta-surface surface may be configured to reflect electromagnetic waves in the predefined frequency range of 24.75 to 27.75 GHz.

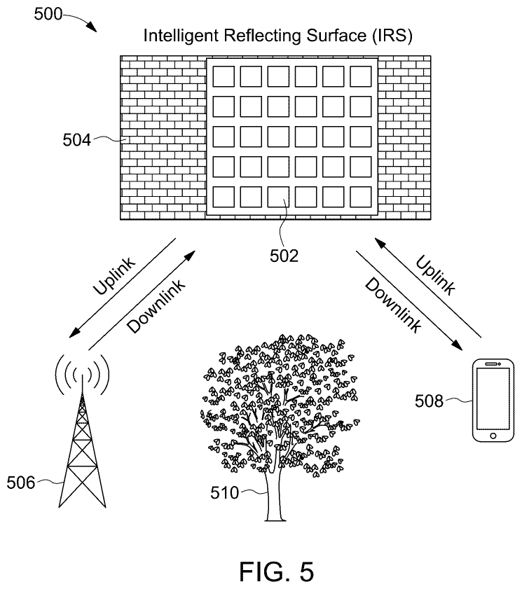

Referring now to FIG. 5, an exemplary deployment scenario 500 of an IRS is illustrated, in accordance with an embodiment of the present disclosure. The IRS 502 (also referred to herein as reflective meta-surface) may be made by arranging the plurality of unit cells 101 side by side in a predefined pattern. Accordingly, the IRS 502 may be attached to a surface such as a wall 504. Further, as shown a line of sight communication between a base station 506 and a user equipment (UE) 508 is obstructed by a tree 510. In absence of the line of sight communication, the signals from the base station 506 and the UE 508 may be reflected using IRS 502 provided on the wall 504. The reflected signals from the IRS 502 enable uninterrupted exchange of communication signals between the base station 506 and the UE 508 even in presence of the obstruction 510. As explained in detail in FIGS. 1-3, each unit cell 101 may include a conducting plane 104 and a loading plane 106 printed on the dielectric substrate 102 to manipulate incident signals having an incident angle in a range of 0 to 30 degrees with respect to a normal of the IRS 502. The conducting plane 104 and the loading plane 106 may minimize the signal energy leakage during IRS's 502 reflection.

In an embodiment, the IRS 502 may be configured to reflect electromagnetic waves in a predefined frequency range of n258 band of the electromagnetic spectrum for wireless communication. Further, the IRS 502 may be configured to reflect electromagnetic waves in the predefined frequency range of 24.75 to 27.75 GHZ.

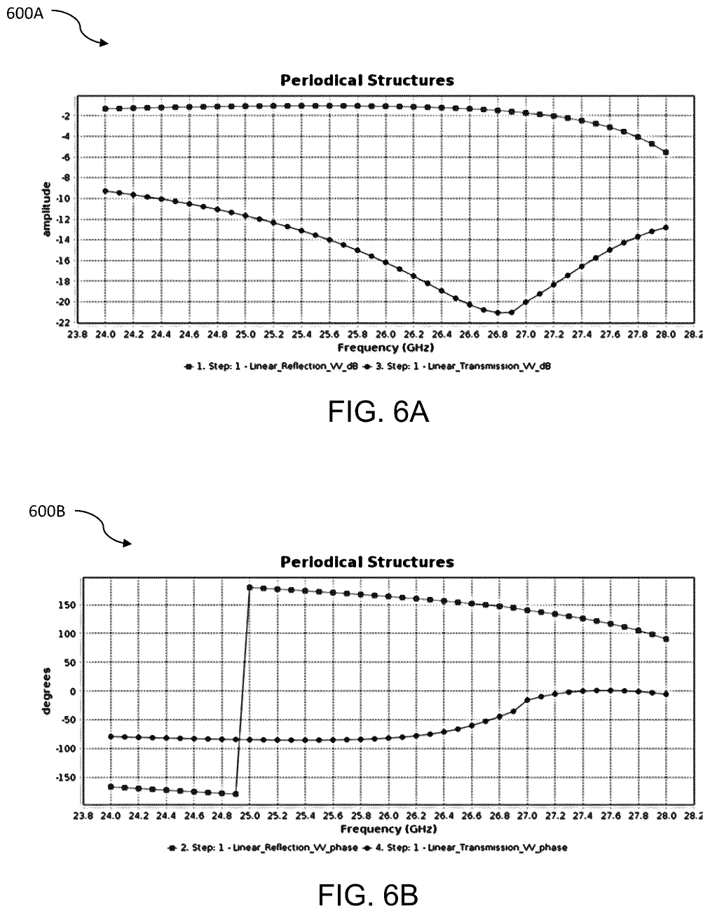

Referring now to FIG. 6A and FIG. 6B, transmission and reflection graphs are shown, in accordance with an embodiment of the present disclosure. The graph 600A depicts the transmission and reflection coefficient (in dB) on the y-axis with respect to frequency of the signal (in GHz) on the x-axis. Further, graph 600B depicts the phase change (in degrees) on the y-axis with respect to the frequency of the signal (in GHz) on x-axis. It is to be noted that the graph 600A depicts that the reflection is best in frequency range of 24 GHz to 27.5 GHZ. Further, the transmission coefficient shows lowest possible transmission in n258 as the transmission curve is below −10 dB mark.

In an embodiment, the reflective meta-surface design of the present disclosure is effective in mitigating distortion in the n258 frequency band range. Thus, the disclosed method and system tries to overcome the technical problem of existing meta-material designs for intelligent reflective surfaces that can redirect beams or signals around obstacles, enhancing communication in non-line-of-sight scenarios.

As will be appreciated by those skilled in the art, the design described in the various embodiments discussed above are not routine, or conventional, or well-understood in the art. The techniques discussed above provide for parasitic reflections that can redirect beams or signals around obstacles, enhancing communication in non-line-of-sight scenarios. The design discussed above is used to produce parasitic reflections that can redirect beams or signals around obstacles, enhancing communication in non-line-of-sight scenarios. The design discussed above is for a meta-surface intended for applications in the 5G/6G communication utilizing mm-wave band, particularly in the n258 frequency range (24-30 GHZ). The design discussed above achieves broadband reflective performance up to an incident angle of 30-35 degrees. The incident angle refers to the angle at which the incoming electromagnetic waves interact with the reflective surface.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described metamaterial based reflective unit cell for intelligent reflective surfaces and method of manufacturing thereof for parasitic reflections that can redirect beams or signals around obstacles, enhancing millimeter communication in non-line-of-sight scenarios. The illustrated steps are set out to explain the exemplary embodiments shown, and it should be anticipated that ongoing technological development will change the manner in which particular functions are performed. These examples are presented herein for purpose of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It is intended that the disclosure and examples be considered as exemplary only, with a true scope of disclosed embodiments being indicated by the following claims.

What is claimed is:

1. A reflective meta-surface, comprising:
a plurality of unit cells arranged in a pre-defined pattern,
wherein each of the plurality of unit cells comprises:
a quadrilateral-shaped substrate of dielectric material comprising a top surface and a bottom surface;
a conducting plane disposed on the top surface; and
a loading plane disposed on the bottom surface,
wherein the conducting plane comprises a first outer surface and a first inner surface,
wherein the first inner surface comprises a first quadrilateral structure with sides parallel to corresponding sides of the top surface of the substrate,
wherein the first outer surface comprises four T-shaped structures,
wherein each of the four T-shaped structures comprises:
a horizontal arm aligned with the corresponding side of the top surface of the substrate, and
a vertical arm comprising a first end and a second end
wherein the first end of the vertical arm is connected to the corresponding horizontal arm and the second end is connected to the corresponding side of the first quadrilateral structure; and
wherein the loading plane comprises a second outer surface and a second inner surface,
wherein the second outer surface comprises a second quadrilateral structure with sides coinciding with corresponding sides of the bottom surface of the substrate,
wherein the second inner surface comprises a plus-shaped structure, and
wherein the conducting plane and the loading plane are placed on the top surface and the bottom surface respectively such that a centre of the plus-shaped structure and a centre of the first quadrilateral structure are colinear.

2. The reflective meta-surface of claim 1, wherein the conducting plane and the loading plane are made of an electrically conductive material.

3. The reflective meta-surface of claim 1, wherein the reflective meta-surface is configured to reflect electromagnetic waves having an incident angle in a range of 0 to 30 degrees with respect to a normal of the reflective meta-surface.

4. The reflective meta-surface of claim 1, wherein the reflective meta-surface is configurable to reflect electromagnetic waves in a predefined frequency range of n258 band of the electromagnetic spectrum for wireless communication.

5. The reflective meta-surface of claim 4, wherein the reflective meta-surface is configured to reflect electromagnetic waves in the predefined frequency range of 24.75 to 27.75 GHz.

6. The reflective meta-surface of claim 4, wherein the disposition of the conducting plane and the loading plane and a dielectric constant of the substrate configures each of the unit cell of the meta-surface to reflect the electromagnetic waves in the predefined frequency range.

7. The reflective meta-surface of claim 1, wherein the pre-defined pattern comprises a first set of unit cells from the plurality of unit cells arranged in x-direction and a second set of unit cells from the plurality of unit cells arranged in y-direction.

8. A method of manufacturing a reflective meta-surface, the method comprising:
arranging a plurality of unit cells in a pre-defined pattern,
wherein each of the plurality of unit cells is formed by disposing a conducting plane on a top surface of a quadrilateral-shaped substrate and a loading plane on a bottom surface of the substrate,
wherein the substrate is made of a dielectric material,
wherein the conducting plane comprises a first outer surface and a first inner surface,
wherein the first inner surface comprises a first quadrilateral structure with sides parallel to corresponding sides of the top surface of the substrate,
wherein the first outer surface comprises four T-shaped structures,
wherein each of the four T-shaped structures comprises:
a horizontal arm aligned with a corresponding side of the top surface of the top surface of the substrate, and
a vertical arm comprising a first end and a second end,
wherein the first end of the vertical arm is connected to the corresponding horizontal arm and the second end is connected to a corresponding side of the first quadrilateral structure; and
wherein the loading plane comprises a second outer surface and a second inner surface,
wherein the second outer surface comprises a second quadrilateral structure with sides coinciding with the corresponding sides of the bottom surface of the substrate,
wherein the second inner surface comprises a plus-shaped structure, and
wherein the conducting plane and the loading plane are placed on the top surface and the bottom surface respectively such that a centre of the plus-shaped structure and a centre of the first quadrilateral structure are colinear.

9. The method of claim 8, wherein the conducting plane and the loading plane are made of an electrically conductive material.

10. The method of claim 8, comprising configuring the reflective meta-surface to reflect electromagnetic waves having an incident angle in a range of 0-30 degrees with respect to a normal of the reflective meta-surface.

11. The method of claim 10, wherein the reflective meta-surface is configured to reflect electromagnetic waves in a predefined frequency range of n258 band of the electromagnetic spectrum for wireless communication.

12. The method of claim 11, wherein the reflective meta-surface is configured to reflect electromagnetic waves in the predefined frequency range of 24.75 to 27.75 GHz.

13. The method of claim 11, wherein the disposition of the conducting plane and the loading plane and a dielectric constant of the substrate configures each of the unit cell of the meta-surface to reflect the electromagnetic waves in the predefined frequency range.
